(19) United States
(12) Patent Application Publication
(10) Pub. No.: US 2009/0267718 A1
(43) Pub. Date: Oct. 29, 2009

(54) Magnetic-field cancellation type transformer

(75) Inventors: Masao Nagano, Saitama (JP); Mitsuaki Hirakawa, Saitama (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd

(21) Appl. No.: 12/385,854

(22) Filed: Apr. 22, 2009

(30) Foreign Application Priority Data
Apr. 24, 2008 (JP) 2008-113326

(51) Int. Cl. H01F 27/06

(52) U.S. Cl. 336/65

(57) ABSTRACT

A magnetic-filed cancellation type transformer includes a primary winding wire and a secondary winding wire which generate magnetic flux when energized, and a core constituted by a magnetic leg portion about which the primary winding wire and the secondary winding wire are wound, and a base for fixing the magnetic leg portion. The primary winding wire and the secondary winding wire are alternately piled and wound on the magnetic leg portion, so that the direction of magnetic flux generated from the primary winding wire and the secondary winding wire are opposite to each other in any couple selected from among the pieces of magnetic flux, and the magnetic flux is cancelled out with each other.

### CROSS-REFERENCE TO RELATED APPLICATION(S)

This application claims the foreign priority benefit under Title 35, United States Code, §119 (V1)-(d), of Japanese Patent Application No. 2008-113326A, filed on Apr. 24, 2008 in the Japan Patent Office, the disclosure of which is herein incorporated by reference in its entirety.

### BACKGROUND OF THE INVENTION

1. Field of the Invention

The present invention relates to a magnetic-field cancellation type transformer for canceling out the pieces of magnetic flux generated from winding wires to convert a voltage.

2. Description of the Related Art

Heretofore, a magnetic-field cancellation type transformer (for example, refer to JP2005-224058A) for canceling out the pieces of magnetic flux generated from a winding wire when energized includes a core about which a primary winding wire and secondary winding wire are wound opposite to each other so that the pieces of magnetic flux generated from the primary and secondary winding wires are cancelled out with each other approximately in one-to-one correspondence. In other words, the magnetic-field cancellation type transformer is constructed in such a manner that the pieces of magnetic flux generated from the primary winding wire and forming a closed magnetic path cancel out with the pieces of magnetic flux generated from the secondary winding wire and forming the closed magnetic path.

Moreover, a conventional magnetic-field cancellation type transformer includes a primary winding wire and a secondary winding wire which are wound and piled on a magnetic leg portion of the core in the vertical direction. Further, the core is normally constituted by at least two blocks which join with each other on a joint surface, in order to facilitate the assembly thereof.

The conventional magnetic-field cancellation type transformer will be described with reference to FIG. 9. The conventional magnetic-field cancellation type transformer 101 includes a separate winding wire 103 constituted by a primary winding wire 103a and a secondary winding wire 103b, which are respectively formed in a mass of the wire. According to the conventional magnetic-field cancellation type transformer 101, the core 105 is asymmetrically constituted by an upper part 105a and a lower part 105b.

The conventional separate winding wire will be described hereinafter. As shown in FIG. 10, the separate winding wire is constituted by the primary winding wire and the secondary winding wire respectively formed in a mass, which are wound and piled in the vertical direction. As shown in the cross sectional shape of the separate winding wire in FIG. 10, the conventional magnetic-field cancellation type transformer 101 including the separate winding wire comprises the primary winding wire 103a and the secondary winding wire 103b, which are separately wound.

Further, a conventional asymmetrical core (EI core) will be described hereinafter. As shown in FIG. 11, the conventional asymmetrical core is constituted by a plate-shaped upper block 105a (formed in an letter I disposed sideways) and a lower block 105b (formed in an letter E disposed sideways), which are shaped differently to each other. The conventional asymmetrical core is asymmetrically formed and joined on the joint surface. As shown in the cross sectional shape of the asymmetrical core in FIG. 11, the cross section of the asymmetrical core is asymmetrically shaped, so that the pieces of magnetic flux generated from the primary winding wire 103a and the secondary winding wire 103b when energized are inhomogeneously cancelled out.

When energized, the pieces of magnetic flux generated from a primary winding wire and a secondary winding wire are cancelled out with each other so that the conventional magnetic-field cancellation type transformer can prevent the magnetic saturation of the core and reduce the size thereof.

However, according to the conventional magnetic-field cancellation type transformer, the primary winding wire and the secondary winding wire are respectively formed in a mass, wound and piled on the magnetic leg core of the core in the vertical direction, so that the magnetic flux density distribution of the core becomes inhomogeneous. Moreover, the magnetic flux forming a closed magnetic path through the joint surface of the core is generated, and the magnetic flux which does not pass through the joint surface of the core but forms the closed magnetic path is generated. Accordingly, the magnetic flux cannot homogeneously be cancelled out, so that residual flux remains.

### SUMMARY OF THE INVENTION

An aspect of the present invention provides a magnetic-filed cancellation type transformer which can reduce residual flux.

A magnetic-filed cancellation type transformer comprises a plurality of winding wires for being wound and generating magnetic flux when energized; and a core which includes a magnetic leg portion about which the plurality of winding wires are wound and a base for fixing the magnetic leg portion, wherein the plurality of winding wires are alternately stacked and wound on the magnetic leg portion, so that the direction of magnetic flux generated from the plurality of winding wires is opposite to each other in any couple selected from among the pieces of the magnetic flux, whereby canceling out each other.

According to the magnetic-filed cancellation type transformer, the winding wires are alternately stacked and wound on the magnetic leg portion, so that the direction of magnetic flux generated from the winding wires when energized is opposite to each other in any couple selected from among the pieces of magnetic flux, and the pieces of magnetic flux can homogeneously be cancelled out.

According to the magnetic-filed cancellation type transformer, the core is a symmetrical core constituted by blocks which are divided in two, and symmetrical about a joint surface on which the blocks are joined.

The magnetic-filed cancellation type transformer includes a symmetrical core which is symmetrical about a joint surface, so that the magnetic flux forming a closed magnetic path through the joint surface of the core becomes homogeneous to the magnetic flux which does not pass through the joint surface and forms the closed magnetic path, thereby canceling out each other.

According to the magnetic-filed cancellation type transformer, the core comprises one piece of magnetic leg portion, and the plurality of winding wires comprise a primary winding wire and a secondary winding wire, and wherein the primary winding wire and the secondary winding wire are alternately stacked and wound on the one piece of magnetic leg portion, so that the direction of magnetic flux generated from the primary winding wire and the secondary winding wire is opposite to each other, whereby canceling out each other.

According to the magnetic-filed cancellation type transformer, the magnetic flux generated from the primary winding wire and secondary winding wire wound on the one magnetic leg portion when energized is opposite to each other, so that the magnetic flux can homogeneously be cancelled out with each other.

According to the present invention, the magnetic flux generated from the winding wires can homogeneously be cancelled out, and the residual flux can be reduced.

### BRIEF DESCRIPTION OF THE DRAWINGS

FIG. 1 is a perspective view of a magnetic-filed cancellation type transformer of an embodiment of the present invention.

FIG. 2 is a circuit diagram including the magnetic-filed cancellation type transformer of an embodiment of the present invention.

FIG. 3 is perspective views which explain a bifilar winding wire.

FIG. 4 is a graph showing voltage step-up rates with respect to the bifilar winding wire and a separate winding wire.

FIG. 5 is a perspective view and a cross-sectional view of a symmetrical core.

FIG. 6 is cross-sectional views of the transformer wherein pieces of residual flux are shown when the bifilar winding is applied.

FIG. 7 is cross-sectional views of the transformer wherein pieces of residual flux are shown when the separate winding wire is applied.

FIG. 8 is cross-sectional views of the transformers showing a variation of residual flux.

FIG. 9 is a perspective view of a conventional magnetic-filed cancellation type transformer.

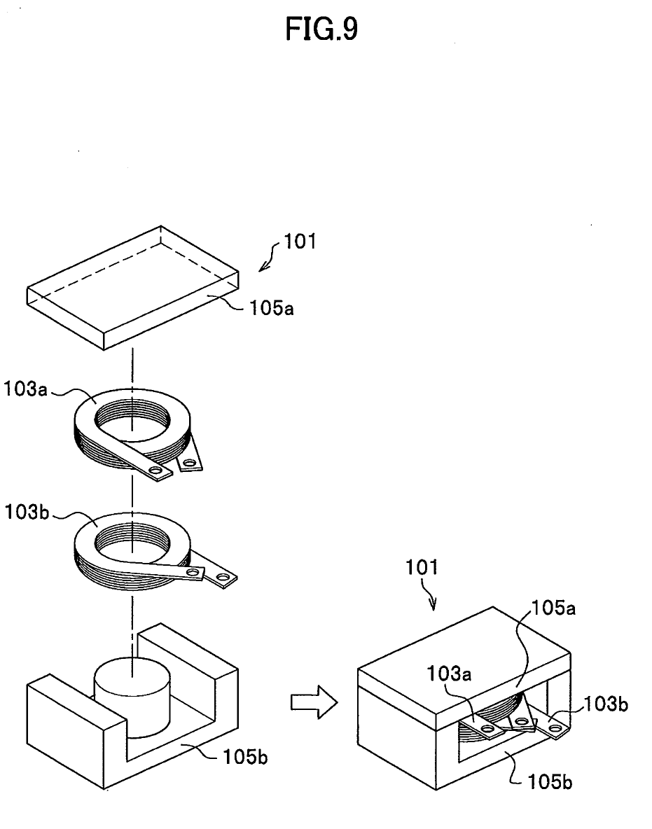

FIG. 10 is a perspective view and a cross-sectional view of a conventional separate winding wire.

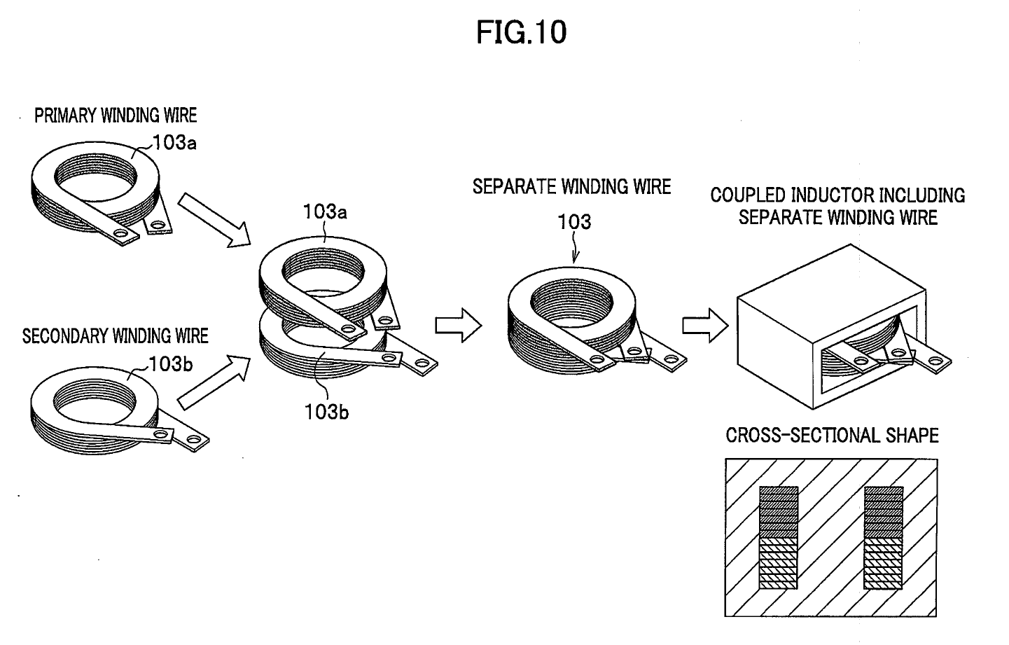

FIG. 11 is a perspective view and a cross-sectional view of a conventional asymmetrical core.

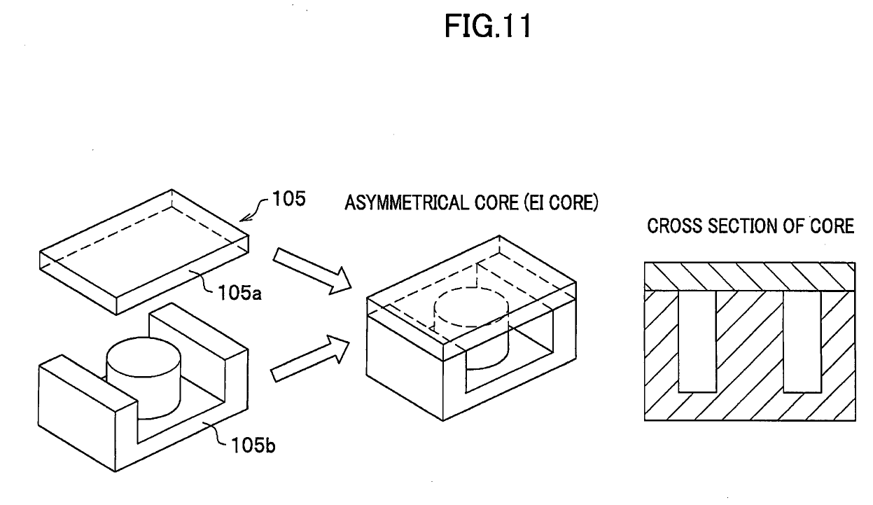

### DETAILED DESCRIPTION OF THE PREFERRED EMBODIMENTS

Next, embodiments of the present invention will be described with reference to drawings in detail.

### [Structure of Magnetic-Filed Cancellation Type Transformer]

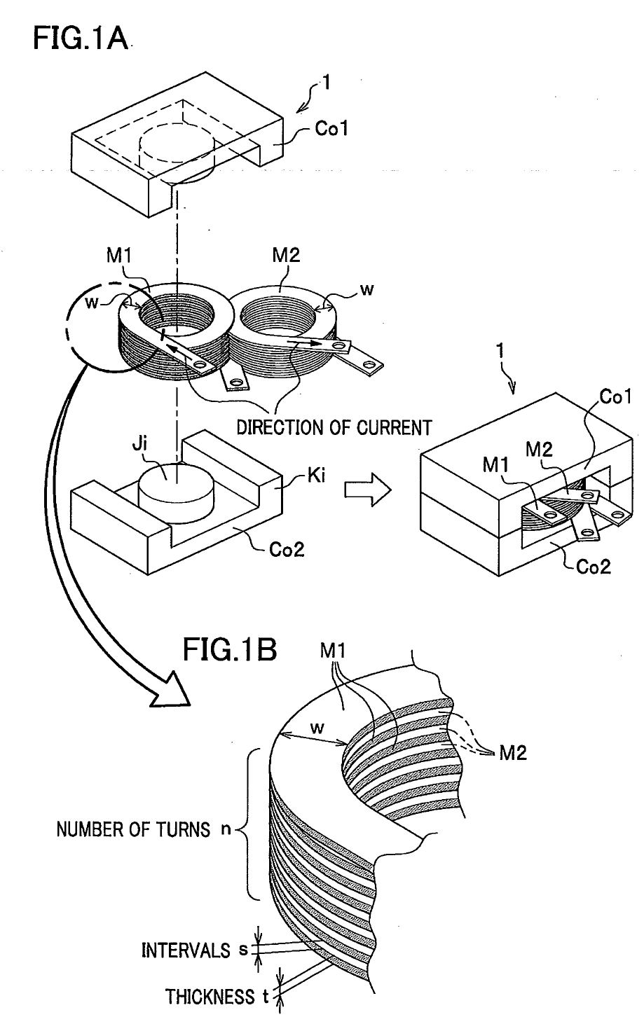

FIG. 1 shows a perspective view of a magnetic-filed cancellation type transformer 1. As shown in FIG. 1, the magnetic-filed cancellation type transformer 1 provides a core Co constituted by two blocks (Co1, Co2) about which a primary winding wire M1 and a secondary winding wire M2 are wound and generate magnetic flux when energized. Magnetic-filed cancellation type indicates that the direction of magnetic flux generated from winding wires wound and disposed in parallel is opposite to each other in any couple selected from among the pieces of the magnetic flux, so that the pieces of magnetic flux counteract each other (cancelled out with each other).

The primary and secondary winding wires are wound and alternately stacked for each turn of the winding wire in the vertical direction, so that the direction of the magnetic flux is opposite to each other when energized. The primary winding wire M1 and the secondary winding wire M2 generate magnetic flux rotating clockwise in the advancing direction of a current when energized. In other words, in the magnetic-filed cancellation type transformer 1, the direction of the current energized in the primary winding wire M1 and the secondary winding wire M2 is opposite to each other (as shown in FIG. 1 where the arrow indicates the advancing direction of the current).

The radius of the primary winding wire M1 and the secondary winding wire M2 to be wound is configured to substantially be equal to that of a magnetic leg portion Ji of the core Co (namely, the space between the winding wires and the magnetic leg portion Ji of the core Co is constituted to be substantially small). The magnetic flux generated from the primary winding wire M1 and the secondary winding wire M2 when energized homogeneously passes through the joint surface of the core Co. Accordingly, the direction of the magnetic flux generated from the primary winding wire M1 and the secondary winding wire M2 is opposite to each other, so that equal closed magnetic path is formed, and the magnetic flux can homogeneously be cancelled out with each other.

According to the primary winding wire M1 and the secondary winding wire M2, the number n of turns of the winding wire, a width w and a thickness t are approximately equal. These winding wires are wound on the magnetic leg portion Ji of the core Co in such a way that the intervals s of the winding wire being wound in the vertical direction can approximately be equal. The materials of a high-conductivity metal (for example, copper, silver, and aluminum) are applied for the primary winding wire M1 and the secondary winding wire M2.

The intervals s of the winding wire being wound in the vertical direction are constituted to be slightly larger than the thickness t of the winding wire. The primary winding wire M1 and the secondary winding wire M2 are alternately stacked and wound. Accordingly, one turn of the secondary winding wire M2 is inserted between the two subsequent turns of the primary winding wire M1. In other words, one turn of the primary winding wire M1 is inserted between the two subsequent turns of the secondary winding wire M2. In the embodiment, the primary winding wire M1 and the secondary winding wire M2 constitute a bifilar winding wire M (whose details are described later).

According to an enlarged view of FIG. 1B showing an enlarged part of the primary winding wire M1 and the secondary winding wire M2, each turn of the secondary winding wire M2 is inserted between the intervals s (shown in a hatching) of the primary winding wire M1 being wound in the vertical direction. Accordingly, in the magnetic-filed cancellation type transformer 1, the primary winding wire M1 and the secondary winding wire M2 are constituted to be alternately stacked.

According to the enlarged view of FIG. 1B showing the enlarged part of the primary winding wire M1 and the secondary winding wire M2, the primary winding wire M1 and the secondary winding wire M2 are wound in a spiral. The primary winding wire M1 is positioned on the secondary winding wire M2 (the upper layer of the spiral winding wires). The secondary winding wire M2 is positioned under the primary winding wire M1 (the lower layer of the spiral winding wires).

The core Co is formed in a substantially rectangular parallelepiped by joining the two blocks (Co1 and Co2) with each other and constituted in a symmetrical form on the boundary between the two blocks. The core Co includes the magnetic leg portion Ji on which the primary winding wire M1 and the secondary winding wire M2 are wound, and a base Ki exclusive of the magnetic leg portion Ji. In the embodiment, the core Co is constituted by a symmetrical-type core (EE core) (details are described later).

The core Co is constructed of metal such as iron (for example, ferrite, silicon steel, and soft magnetic material). The joint surface of the core Co is formed in order to integrally join the two blocks (Co1 and Co2) with each other by sintering a metal powder of the same metal as that of the two blocks (Co1 and Co2). Moreover, the core Co can be formed by stacking silicon steel plates.

The magnetic leg portions of the core Co are a section about which the primary winding wire M1 and the secondary winding wire M2 are wound. In the embodiment, the magnetic leg portions Ji are formed in a cylindrical shape and disposed approximately in the middle of the two blocks (Co1 and Co2).

The base Ki of the core Co is another section about which the primary winding wire M1 and the secondary winding wire M2 are not wound.

The magnetic-filed cancellation type transformer 1 includes the primary winding wire M1 and the secondary winding wire M2 which are stacked with each other and wound on the magnetic leg portion Ji of the core Co, so that the pieces of magnetic flux generated from the primary winding wire M1 and the secondary winding wire M2 when energized can homogeneously be cancelled out, and the residual flux can be reduced.

According to the magnetic-filed cancellation type transformer 1, one turn of the secondary winding wire M2 is inserted between the two subsequent turns of the primary winding wire M1. In other words, one turn of the primary winding wire M1 is inserted between the two subsequent turns of the secondary winding wire M2. Since the direction of the current energized in the primary winding wire M1 and the secondary winding wire M2 is opposite to each other, the pieces of the magnetic flux generated from adjacent winding wires when energized are cancelled out with each other. Conventionally, the primary winding wire M1 and the secondary winding wire M2 are piled by the mass in the vertical direction. The present invention can cancel out the pieces of magnetic flux generated from the adjacent winding wires more steadily than heretofore, and reduce the residual flux.

### [Exemplification of a Circuit Including the Magnetic-Filed Cancellation Type Transformer]

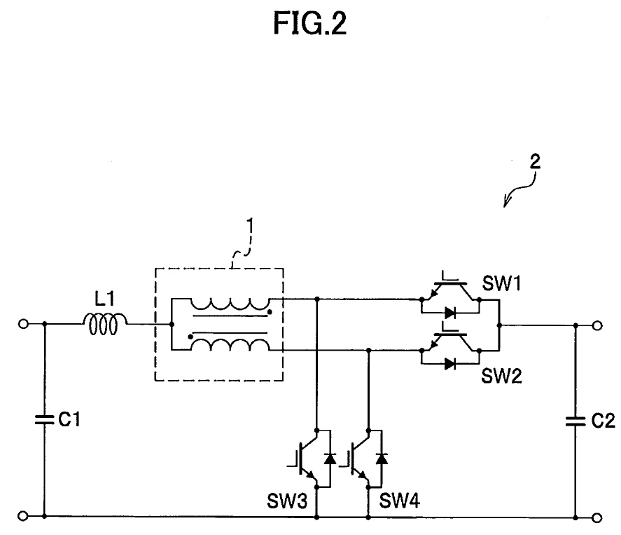

Next, an electric power converter including the magnetic-filed cancellation type transformer 1 will be described with reference to FIG. 2. The electric power converter 2 shown in FIG. 2 is a DC-DC converter which steps up/down a voltage (input voltage) applied to one terminal and outputs the voltage to the other terminal by providing the magnetic-filed cancellation type transformer 1 (coupled inductor). The electric power converter 2 includes the magnetic-filed cancellation type transformer 1, an inductor L1, two capacitors C1 and C2, and four switching elements SW1, SW2, SW3, and SW4.

The electric power converter 2 controls the on/off of the switching elements SW1, SW2, SW3, and SW4, charges an emission current from the inductor L1 into the capacitors C1 and C2, and discharges the accumulated charge. Accordingly, the electric power converter 2 steps up/down the voltage (input voltage) into a desirable voltage value. In this case, the magnetic-filed cancellation type transformer 1 reduces the residual flux caused by a direct current, thereby allowing the electric power converter 2 to step up the voltage at a high step-up rate and output a high voltage, and providing a wide range of operation.

For example, the electric power converter 2 controls the on/off of the switching elements SW2 and SW4, and charges the emission current from the inductor L1 into the capacitor C2, so that the electric power converter 2 can perform a step-up operation. In this case, according to the magnetic-filed cancellation type transformer 1, when the emission current from the inductor L1 is energized, the direction of the magnetic flux generated from the primary winding wire M1 and the secondary winding wire (FIG. 1B) which are alternately stacked with each other M2 is opposite to each other, so that the pieces of the magnetic flux are securely cancelled out with each other.

### [Bifilar Winding Wire]

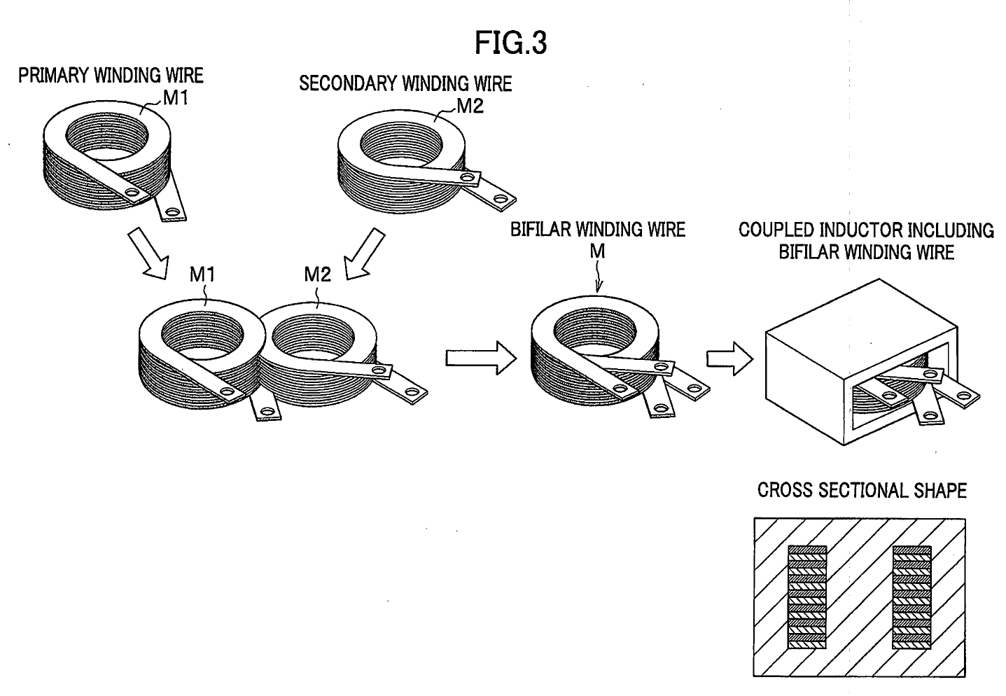

Next, a bifilar winding wire will be described with reference to FIG. 3.

As shown in FIG. 3, the bifilar winding wire comprises the primary winding wire M1 and the secondary winding wire M2 which are wound and alternately stacked with each other in the vertical direction. The magnetic-filed cancellation type transformer 1 includes the bifilar winding wire wound on the core Co. In FIG. 3 showing a cross-section shape, the primary winding wire M1 and the secondary winding wire M2 are alternately wound.

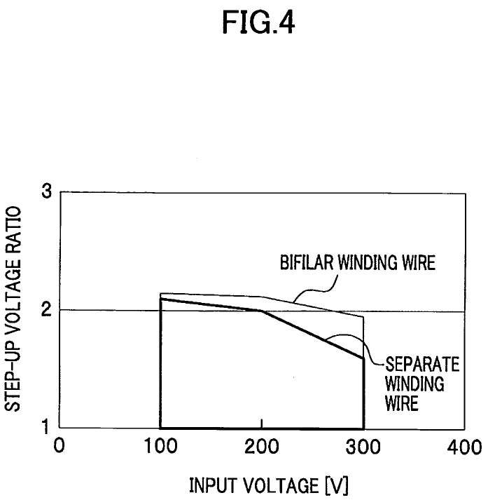

FIG. 4 is a graph showing the measured values of the step-up voltage rate when the bifilar winding wire is applied and when a separate winding wire is applied.

As shown in FIG. 4, when the input voltage ranges from 100 V to 300 V, there arises a difference in the step-up voltage rates of the separate winding wire and the bifilar winding wire. Especially, when the input voltage is in the vicinity of 300 V, the step-up voltage rate of the separate winding wire is only about 1.5 times the input voltage. However, when the bifilar winding wire is applied, the step-up voltage rate of bifilar winding wire increases up to about twice as much as the input voltage.

### [Symmetrical Core]

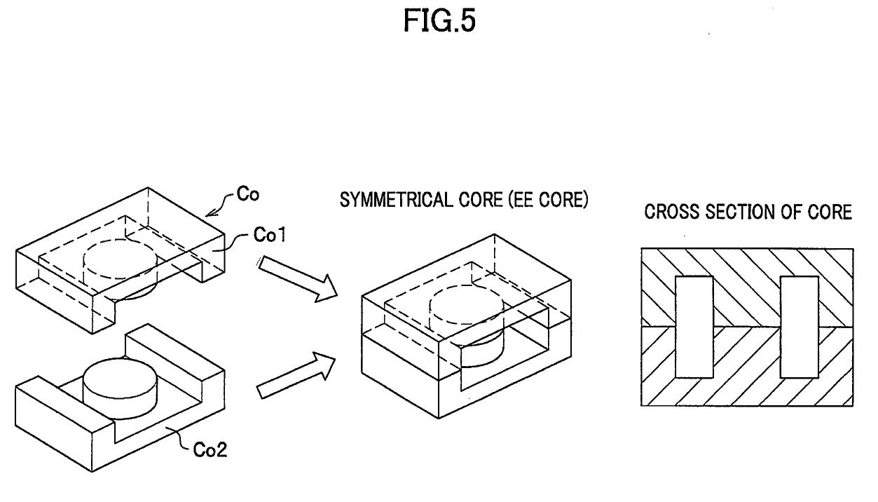

Next, a symmetrical core will be described with reference to FIG. 5.

As shown in FIG. 5, the magnetic-filed cancellation type transformer 1 includes the symmetrical core (EE core) for the core Co. The symmetrical core is constituted by two blocks which are of the same shape (both two blocks are shaped in an letter E disposed sideways). The cores Co are symmetrical about the joining surface. In FIG. 5 showing a cross sectional shape, the cross section of the core Co is symmetrical about the line of the joining surface.

### [Mechanism For Generating Residual Flux]

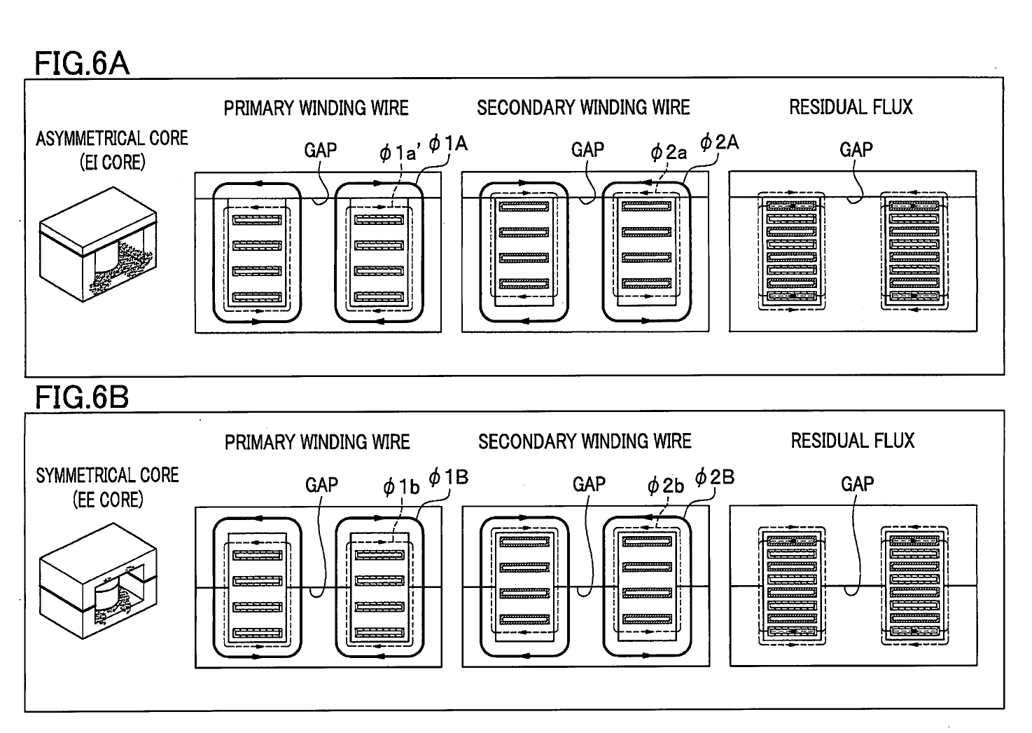

Next, according to the magnetic-filed cancellation type transformer 1, a mechanism for generating residual flux (residual flux caused by a direct current) will be described with reference to FIGS. 6 to 8. The mechanism for generating residual flux will be described in four cases as follows; the bifilar winding wire wound on the asymmetrical core (EI core), the bifilar winding wire wound on the symmetrical core (EE core, magnetic-filed cancellation type transformer 1), the separate winding wire wound on the asymmetrical core (magnetic-filed cancellation type transformer 101), the separate winding wire wound on the asymmetrical core.

As shown in FIG. 6A, where the bifilar winding wire is wound on the asymmetrical core (EI core), primary magnetic flux generated from the primary winding wire is constituted by magnetic flux φ1a′ which does not pass through a gap (joining surface), and magnetic flux φ1A which passes through the gap. On the other hand, secondary magnetic flux generated from the secondary winding wire is constituted by magnetic flux φ2a which passes through the gap. However, magnetic flux φ2a′ which does not pass through the gap (joining surface) is not generated. Accordingly, the pieces of the primary magnetic flux and the secondary magnetic flux to be cancelled out become inhomogeneous. As a result, the residual flux generated from the bifilar winding wire wound on the asymmetrical core slightly remains, although the residual flux is reduced.

As shown in FIG. 6B, where the bifilar winding wire is wound on the symmetrical core (EE core, magnetic-filed cancellation type transformer 1), the primary magnetic flux generated from the primary winding wire is constituted only by the magnetic fluxes φ1B and φ1b which pass through the gap. The secondary magnetic flux generated from the secondary winding wire is constituted only by the magnetic fluxes φ2B and φ2b which pass through the gap. According to the primary and secondary winding wires, the magnetic flux which does not pass through the gap (joining surface) is practically not generated. Accordingly, the pieces of the primary magnetic flux and the secondary magnetic flux to be cancelled out become homogeneous. As a result, the residual flux can be reduced to almost nothing.

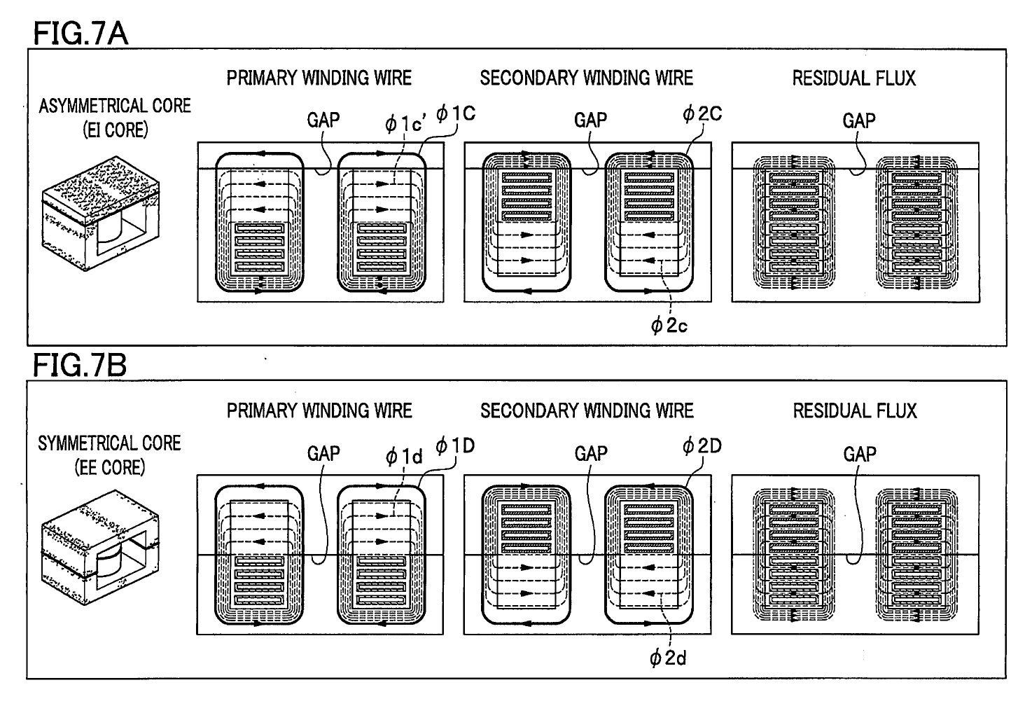

As shown in FIG. 7A, where the separate winding wire is wound on the asymmetrical core (EI core, magnetic-filed cancellation type transformer 101), the primary magnetic flux generated from the primary winding wire is constituted by magnetic flux φ1c′ which does not pass through the gap (joining surface), and magnetic flux φ1c which passes through the gap. On the other hand, the secondary magnetic flux generated from the secondary winding wire is constituted only by magnetic fluxes φ2C and φ2c which pass through the gap. However, magnetic flux φ2c′ which does not pass through the gap (joining surface) is practically not generated. Accordingly, the pieces of the primary magnetic flux and the secondary magnetic flux to be cancelled out become inhomogeneous. Moreover, since the separate winding wire is applied, the pieces of magnetic flux to be cancelled out is low in quantity with respect to the primary magnetic flux and the secondary magnetic flux. As a result, much residual flux remains.

As shown in FIG. 7B, where the separate winding wire is wound on the symmetrical core (EE core), the primary magnetic flux generated from the primary winding wire is constituted only by the magnetic fluxes φ1D and φ1d which pass through the gap. The secondary magnetic flux generated from the secondary winding wire is constituted only by the magnetic fluxes φ2D and φ2d which pass through the gap. According to the primary and secondary winding wires, the magnetic flux which does not pass through the gap (joining surface) is practically not generated. Accordingly, the pieces of the primary magnetic flux and the secondary magnetic flux to be cancelled out become homogeneous. However, since the separate winding wire is applied, the pieces of magnetic flux to be cancelled out is low in quantity with respect to the primary magnetic flux and the secondary magnetic flux. As a result, much residual flux remains.

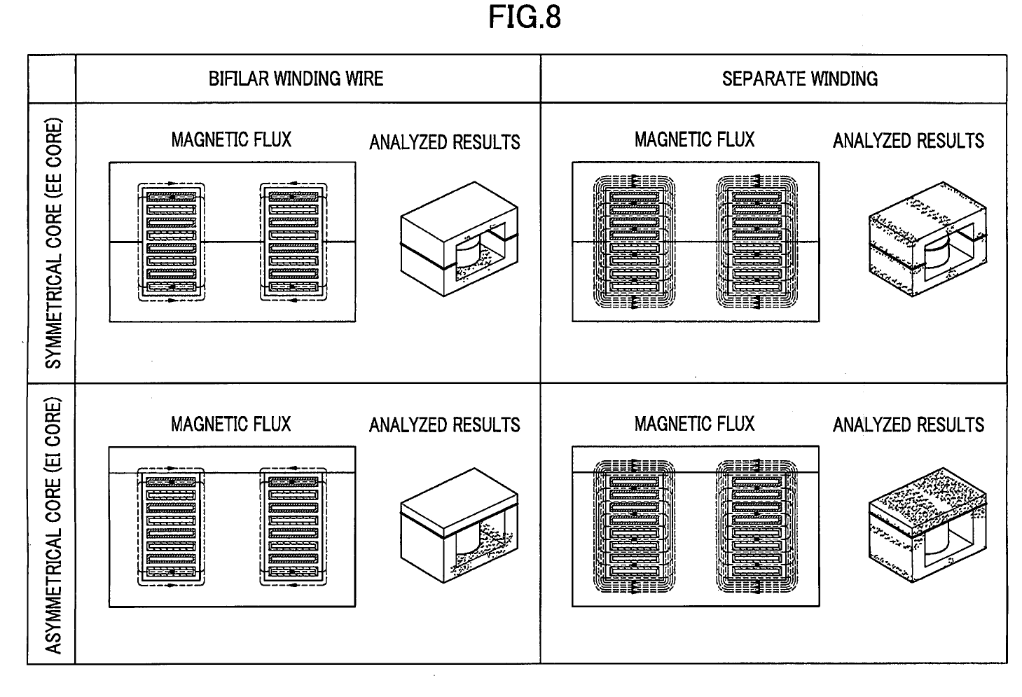

A variation of residual flux caused by a direct current shown in FIGS. 6 and 7 will be described with reference to FIG. 8 en masse.

As shown in FIG. 8, when the bifilar winding wire wound on the symmetrical core is applied to the magnetic-filed cancellation type transformer 1, the residual flux is substantially reduced. When the bifilar winding wire wound on the asymmetrical core is applied, the residual flux is reduced, which is the second most effective combination in reducing the residual flux. When the separate winding wire wound on the symmetrical core is applied, much residual flux remains. Further, when the separate winding wire wound on the asymmetrical core is applied, much residual flux remains to a great extent. In view of analyzed results, when the bifilar winding wire is applied, the pieces of residual flux can be reduced to approximately one tenth, compared with the separate winding wire applied. When the symmetrical core is applied, the pieces of residual flux can additionally be reduced to about several percents, compared with the asymmetrical core applied.

In FIG. 8, a hatching illustrated on the cores shows the residual flux. The magnitude of the residual flux is described in the order as follows; the residual flux generated from the bifilar winding wire wound on the symmetrical core, the residual flux generated from the bifilar winding wire wound on the asymmetrical core, the residual flux generated from the separate winding wire wound on the symmetrical core, the residual flux generated from the separate winding wire wound on the asymmetrical core.

The embodiments of the present invention are not limited but can be modified. For example, in the embodiments, the bifilar winding wire M is wound on one magnetic leg portion Ji. However, a plurality of magnetic leg portions Ji may as well be applied. In this case, the plurality of magnetic leg portions need to be disposed in such a manner that the intervals between the magnetic leg portions are homogeneous.

We claim:

1. A magnetic-filed cancellation type transformer comprising:
a plurality of winding wires for being wound and generating magnetic flux when energized; and
a core comprising
a magnetic leg portion about which the plurality of winding wires are wound; and
a base for fixing the magnetic leg portion, wherein
the plurality of winding wires are alternately stacked and wound on the magnetic leg portion, so that the direction of magnetic flux generated from the plurality of winding wires is opposite to each other in any couple selected from among the pieces of the magnetic flux, whereby canceling out each other.

2. The magnetic-filed cancellation type transformer according to claim 1, wherein the core is a symmetrical core constituted by blocks which are divided in two, and symmetrical about a joint surface on which the blocks are joined.

3. The magnetic-filed cancellation type transformer according to claim 1, wherein the core comprises one piece of magnetic leg portion, and the plurality of winding wires comprise a primary winding wire and a secondary winding wire, and wherein the primary winding wire and the secondary winding wire are alternately stacked and wound on the one piece of magnetic leg portion, so that the direction of magnetic flux generated from the primary winding wire and the secondary winding wire is opposite to each other, whereby canceling out each other.
